(19) United States
(12) Patent Application Publication
(10) Pub. No.: US 2015/0173391 A1
(43) Pub. Date: Jun. 25, 2015

(54) METHODS AND SUBSYSTEMS FOR PROVIDING SELECTABLE COOLING TO FREEZING PRODUCT RELATED SYSTEMS

(71) Applicant: ELVARIA LLC, Reston, VA (US)

(72) Inventors: Richard NEHRBOSS, Bumpass, VA (US); Adam ROSSI, Oakton, VA (US)

(21) Appl. No.: 14/579,447

(22) Filed: Dec. 22, 2014

Related U.S. Application Data
(60) Provisional application No. 61/920,678, filed on Dec. 24, 2013.

(51) Int. Cl. A23G 9/22; A23L 3/36

(52) U.S. Cl. CPC A23G 9/22; A23L 3/362

(57) ABSTRACT

Methods and systems for providing selectable cooling to freezing products, including freezing product producing subsystem components that may be variably interchanged, such as by interchanging the methods/subsystems for cooling as appropriate for various conditions. Such conditions may include one or more of sensed external temperature, sensed water pressure/presence, and/or sensed water temperature. The systems may include a freezing product producing subsystem having a heat exchanger component; a product dispensing subsystem interoperable with the freezing product producing subsystem; at least two cooling subsystems interoperable with the heat exchanger component of the freezing product producing subsystem to provide cooling; and a control subsystem wherein the control subsystem is configured to selectively control the implementation of the at least two cooling subsystems. Methods of using the same are also provided.

### CROSS-REFERENCE TO RELATED APPLICATIONS

This application claims priority to U.S. Provisional Application No. 61/920,678, filed Dec. 24, 2013. The disclosure of the prior application is hereby incorporated in its entirety by reference.

### BACKGROUND

### Field of the Invention

Aspects of the present invention are directed to methods and systems for cooling hard and soft ice cream machines and/or other freezing/cooling units, including one or more methods and/or systems or subsystems involving variably, such as automated, switching among cooling method/systems/subsystems as appropriate for ambient and other circumstances.

### SUMMARY OF THE INVENTION

One variation in accordance with aspects of the present invention provides multiple methods and subsystems for providing cooling in a refrigeration cycle for freezing machines. In one variation, the multiple methods/subsystem components may be variably interchanged, such as by interchanging the methods/subsystems for cooling as appropriate for various conditions, including, for example, based on one or more of sensing external temperature, sensing water pressure/presence, and/or sensing water temperature.

Additional advantages and novel features in accordance with aspects of the present invention will be set forth in part in the description that follows, and in part will become more apparent to those skilled in the art upon examination of the following or upon learning by practice thereof.

### BRIEF DESCRIPTION OF THE FIGURES

In the drawings:

FIG. 1 shows an example of a refrigeration system of the related art that includes an air cooled condenser cooled using a fan.

FIG. 2 shows an example of a refrigeration system of the related art that includes a water cooled condenser.

FIG. 3 contains a representative block diagram of various system and subsystem components of an example freezing product related system, in accordance with aspects of the present invention.

FIG. 4 presents an example diagram of a method of providing cooling for an example freezing product related system using an air cooled and a water cooled subsystems, in accordance with aspects of the present invention.

FIG. 5 contains a representative diagram of an example computer system capable of carrying out functionality described in example implementations, in accordance with aspects of the present invention.

FIG. 6 is a representative diagram of various example system components, for use in accordance with aspects of the present invention.

### DETAILED DESCRIPTION

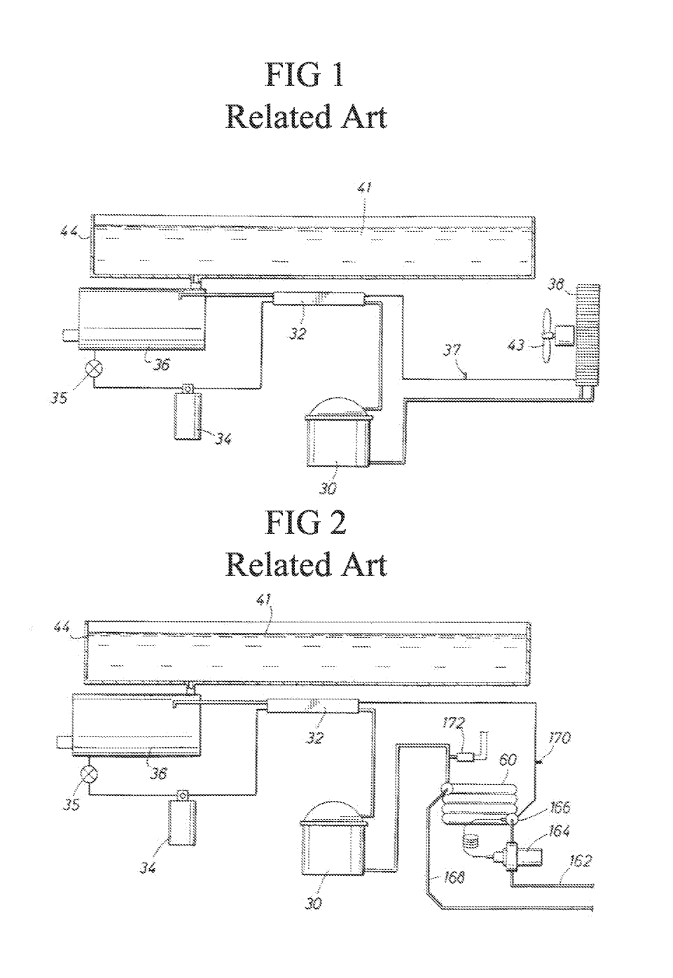

Aspects of the present invention are directed to methods of cooling hard and soft ice cream machines or other freezing/cooling units, including one or more methods and/or systems or subsystems involving variably, such as automated, switching among cooling method/systems/subsystems as appropriate for ambient and other circumstances. FIG. 1 shows various features of an example of a refrigeration system of the related art that includes an air cooled condenser cooled using a fan (see FIG. 7 and related description of U.S. Pat. No. 6,082,123). FIG. 2 shows various features of an example of a refrigeration system of the related art that includes a water cooled condenser (see FIG. 8 and related description of U.S. Pat. No. 6,082,123).

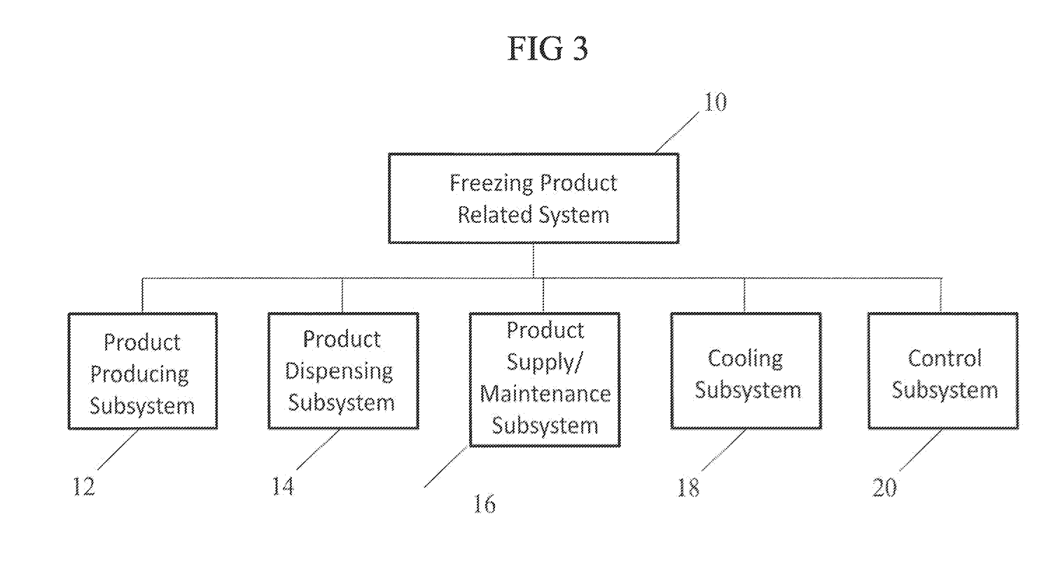

Aspects of the present invention include various features relating to ice cream production and/or other freezing or cooling, including, in one example implementation, those for use in conjunction with frozen dessert machines. As shown in FIG. 3, such a system 10 (e.g., a frozen dessert machine) may, for example, via a product producing subsystem 12, freeze a mix that flows from the top hoppers into the freezing cylinders, in which augers blend the product to prevent it from freezing hard. When product is dispensed (e.g., within a product dispensing subsystem 14), new liquid flows down into the freezing cylinder. In addition to frozen dessert machines, other application also may operate similarly, such as batch freezers, ice makers, frozen yogurt machines, frozen custard machines, and similar equipment.

Such freezing device applications (the systems for which are interchangeably referred to herein as “freezing product related systems”) typically use a compressor with a refrigeration cycle that needs to be cooled (e.g., via a cooling subsystem 18). As a result, such freezing product related systems must dissipate the heat produced during operation. Heat dissipation may be accomplished via one or more of the following features:
1) Use of a heat exchanger for condensing a refrigerant (also interchangeably referred to herein as a “condenser”) in which refrigerant flows in conjunction fan blowing (air cooling). For example, the refrigerant may flow through a coil and air may be blown over the coils as the refrigerant passes therethrough. An example of a condenser cooled by air may be found in U.S. Pat. No. 6,082,123, which is incorporated by reference in its entirety herein.
2) Use of a heat exchanger for condensing refrigerant in which water flows therepast, and thereby flow in proximity to the contained refrigerant; for example, city water may be so used, which is discharged to a drain. In operation, for example, the refrigerant may flow through a first coil while cool water may flow through a second coil in proximity to the coil containing the refrigerant. An example of a condenser cooled by water may be found in U.S. Pat. No. 6,082,123, which is incorporated by reference in its entirety herein.
3) Use of a heat exchanger for condensing refrigerant, in which fluid like glycol flows therepast, the glycol then being circulated in a closed loop to a “chiller” outside of the building. For example, the refrigerant may flow through a first coil, while the cool glycol may flow through a second coil in proximity to the coil containing the refrigerant.

In the above, generally, water-cooled subsystems may circulate water through the machine and then discharge the warm water (e.g., down a drain). Air-cooled machines depend on air cooling features, such as the building air conditioning and ventilation, to provide the flow that cools the heat exchange features.

Water-cooling is more reliable in most circumstances because such subsystems provide a dedicated cooling system with highly effective heat transfer. The disadvantages of this type of subsystem include the requirement of sufficient plumbing to deliver water to and from the machines, and the possible limitations that the need for plumbing may have on specific placement of the machines.

Air-cooling is attractive, for example, when the environmental conditions are mild and well controlled. Ambient temperatures of 70-75 degrees Fahrenheit may be preferred when operating frozen dessert machines, for example. Performance and equipment reliability may suffer at temperatures much higher than the above range. Manufacturers often provide specific guidance about cooling requirements for air-cooled systems. Failure to follow this guidance may lead to problems, such as component failure and machine down time, which results in lost revenue. Water-cooling is generally a better choice if available and if only a single subsystem is suitable.

One example implementation in which air-cooling may work well is when the frozen dessert system is built, for example, into a wall for customer self-service, where an open area behind the machines typically exists for store staff to add product, clean the machines, etc. (e.g., as part of product supply/maintenance subsystem 16 shown in FIG. 3). Among other things, this configuration ensures adequate airflow around the machines for air-cooling to be reliable and effective.

It is also sometimes advantageous to provide options for switching between water and air cooling subsystems as conditions may dictate. Such switching decisionmaking and control may be provided, for example, via various data inputs, such as one or more sensors, and one or more processing devices in a control subsystem 20 of FIG. 3.

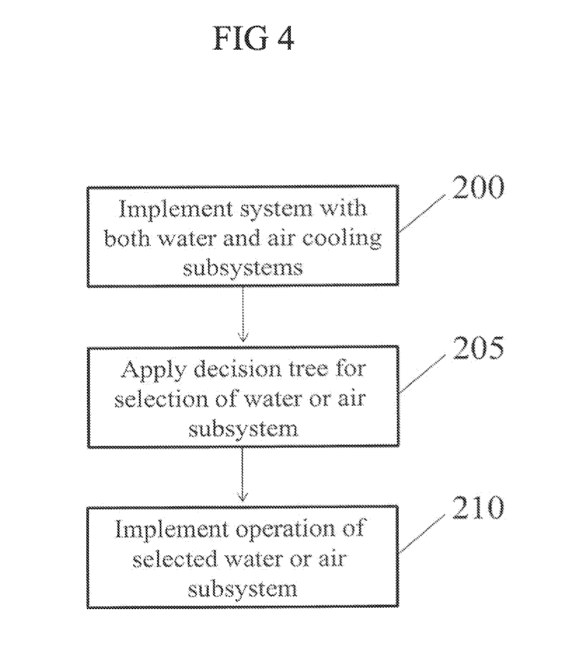

In accordance with the above, one example implementation in accordance with aspects of the present invention includes the addition of a heat exchanger to an air cooled machine, or vice versa 200, as shown in FIG. 4. Among other advantages, this example implementation allows either manual control or automated control of the particular cooling method/subsystem used, depending on circumstances. Manual control, for example, may include further providing a user operated switch, to enable user selected air or water cooling, for example, upon demand, depending on situation needs (e.g., environmental, energy, and/or other considerations, at the time a switch decision is appropriate).

Automatic control may include, for example, a circuit or computer control that applies a decision tree or other determination methodology to select which cooling subsystem to use for cooling 205. Such determination methodology may include some or all of the following inputs: sensing external temperature, sensing water pressure/presence, sensing water temperature and using either preset or operator definable parameters to automatically switch from one cooling method to the other. For example, the control unit in a soft-serve ice cream machine may be programmed to automatically switch from air-cooling to water-cooling when the ambient air temperature exceeds 78 degrees Fahrenheit, upon which event, the sensor, sensing the temperature limit being reached, may cause the system to automatically switch cooling subsystems (e.g., by output wired or wireless signal being communicated to logic, such as a transistor input or processor based system signal input, for controlling a switch operation and/or other automatic operational functions for changing from water cooled operation to air cooled operation). Alternatively, for example, the soft-serve ice cream machine may be scheduled by a timing circuit to automatically switch from water cooling to air cooling during nighttime hours, when off-peak electricity costs may be lower.

In yet another example implementation, the control unit in the soft-serve ice cream machine may automatically switch from water cooling to air cooling when the machine detects water pressure below a predetermined threshold. Among other advantages, this approach may prevent the equipment from overheating and becoming damaged.

Once the determination of which cooling subsystem has been completed, the control subsystem may implement cooling via the selected subsystem 210.

General potential benefits of use of a manually or automatically selectively switched air and water cooled subsystems include the following:
1) Air cooled subsystem may be used when the ambient climate is colder, such as in winter, thereby lowering heat required in the store or other facility housing the system, and thus potentially lowering utility bills;
2) Water cooled subsystem may be used when the ambient climate is warmer, such as summer, thereby lowering requirements for air conditioning (e.g., reducing the need to dissipate heat produced within a facility by an air cooled system);
3) Use of selectively variable subsystems allows movement by user of equipment to locations with differing cooling requirements (e.g., user is not “locked into” one type of cooling in the event that changing conditions require a changed decision tree for subsystem selection);
4) Use of selectively variable subsystems allows manufacturers and resellers to manage, stock, etc, fewer inventoried items (e.g., less SKU's); and
5) Use of selectively variable subsystems may help with prevention and/or mitigation of potential damage to equipment, such as through overheating or in the event one subsystem fails, as the other subsystem may provide a backup.

Potential applications include the following:

1) Ice cream batch freezers;

2) Soft serve machines, frozen yogurt machines, frozen custard machines;

3) Other systems with refrigeration cycle where condensing unit is located indoors.

Switching between the air cooled subsystem and the water cool (or other liquid cooling, such as glycol cooled) subsystem may be performed by actuating a valve to redirect the flow of refrigerant. For example, when the valve is a first position, refrigerant will flow through the air cooled subsystem. Then, when the valve is actuated, the refrigerant may be directed to bypass the air cooled subsystem and be redirected to the water cooled subsystem. In this manner, an overall system may include both the air cooled and water cooled subsystems (e.g., may include a first condenser cooled by air and a second condenser cooled by water). In another aspect, the valve may split the flow of refrigerant, such that some refrigerant flows to the two subsystems simultaneously. In this case, both the air cooled and the water cooled (or other liquid cooled) subsystems may be operated conemporaneously. The ratio of the split can be varied. For example, the refrigerant flow may be split (measured in percent flow rate) 50/50, 60/40, 70/30, 75/25, 85/15, or 90/10, etc.

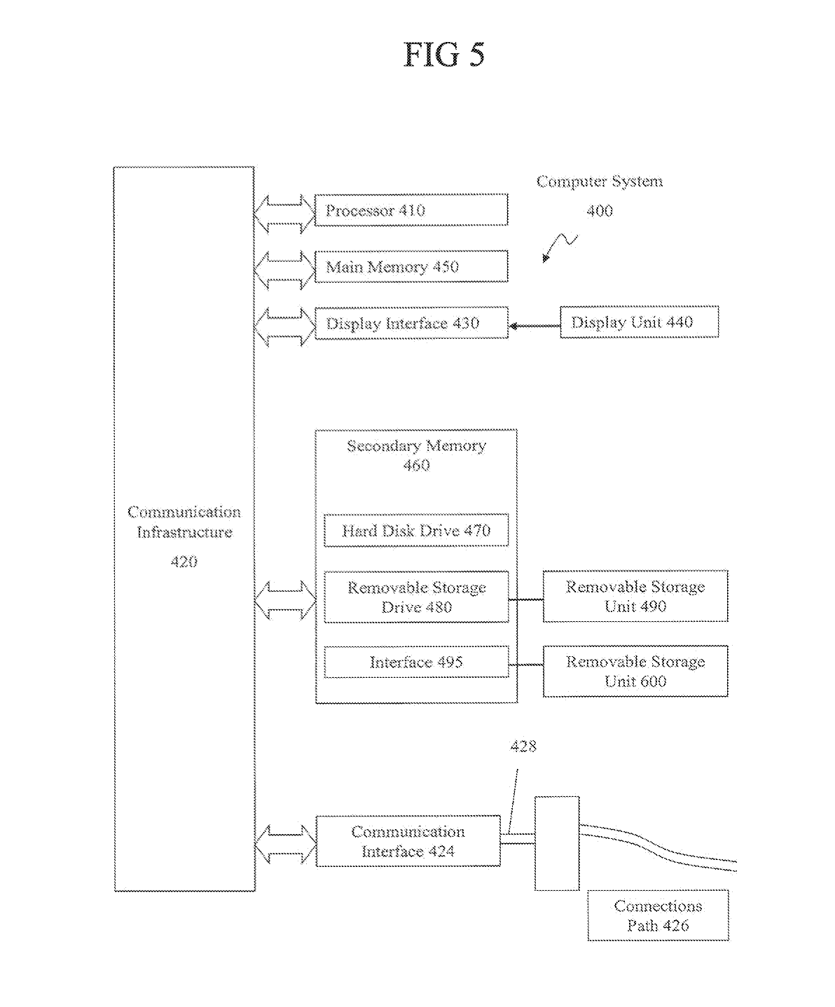

Various aspects of the present invention, such as the control system for automatically selecting between cooling subsystems, may be implemented using hardware, software, or a combination thereof and may be implemented in one or more computer systems or other processing systems. In an aspect of the present invention, features are directed toward one or more computer systems capable of carrying out the functionality described herein. An example of such a computer system 400 is shown in FIG. 5.

Computer system 400 includes one or more processors, such as processor 404. The processor 410 is coupled to a communication infrastructure 420 (e.g., a communications bus, cross-over bar, or network). Various software aspects are described in terms of this example computer system. After reading this description, it will become apparent to a person skilled in the relevant art(s) how to implement aspects hereof using other computer systems and/or architectures.

Computer system 400 may include a display interface 430 that forwards graphics, text, and other data from the communication infrastructure 420 (or from a frame buffer not shown) for display on a display unit 440. Computer system 400 may include a main memory 450, preferably random access memory (RAM), and may also include a secondary memory 460. The secondary memory 460 may include, for example, a hard disk drive 470 and/or a removable storage drive 480, representing a floppy disk drive, a magnetic tape drive, an optical disk drive, etc. The removable storage drive 480 may read from and/or write to a removable storage unit 490 in a well-known manner. Removable storage unit 490, represents a floppy disk, magnetic tape, optical disk, etc., which may be read by and written to removable storage drive 480. As will be appreciated, the removable storage unit 418 may include a computer usable storage medium having stored therein computer software and/or data.

Alternative aspects of the present invention may include secondary memory 460 and may include other similar devices for allowing computer programs or other instructions to be loaded into computer system 400. Such devices may include, for example, a removable storage unit 490 and an interface 495. Examples of such may include a program cartridge and cartridge interface (such as that found in video game devices), a removable memory chip (such as an erasable programmable read only memory (EPROM), or programmable read only memory (PROM)) and associated socket, and other removable storage units 490 and interfaces 495, which allow software and data to be transferred from the removable storage unit 490 to computer system 400.

Computer system 400 may also include a communications interface 424. Communications interface 424 may allow software and data to be transferred among computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 may be in the form of signals 428 which may be electronic, electromagnetic, optical or other signals capable of being received by communications interface 424. These signals 428 may be provided to communications interface 424 via a communications path (e.g., channel) 426. This path 426 may carry signals 428 and may be implemented using wire or cable, fiber optics, a telephone line, a cellular link, a radio frequency (RF) link and/or other communications channels. As used herein, the terms “computer program medium” and “computer usable medium” refer generally to media such as a removable storage drive 480, a hard disk installed in hard disk drive 470, and/or signals 428. These computer program products may provide software to the computer system 400. Aspects of the present invention are directed to such computer program products.

Computer programs (also referred to as computer control logic) may be stored in main memory 450 and/or secondary memory 460. Computer programs may also be received via communications interface 424. Such computer programs, when executed, may enable the computer system 400 to perform the features in accordance with aspects of the present invention, as discussed herein. In particular, the computer programs, when executed, may enable the processor 410 to perform the features in accordance with aspects of the present invention. Accordingly, such computer programs may represent controllers of the computer system 400.

Where aspects of the present invention may be implemented using software, the software may be stored in a computer program product and loaded into computer system 400 using removable storage drive 414, hard drive 412, or communications interface 420. The control logic (software), when executed by the processor 404, may cause the processor 404 to perform the functions described herein. In another aspect of the present invention, the system may be implemented primarily in hardware using, for example, hardware components, such as application specific integrated circuits (ASICs). Implementation of the hardware state machine so as to perform the functions described herein will be apparent to persons skilled in the relevant art(s).

In yet another variation, aspects of the present invention may be implemented using a combination of both hardware and software.

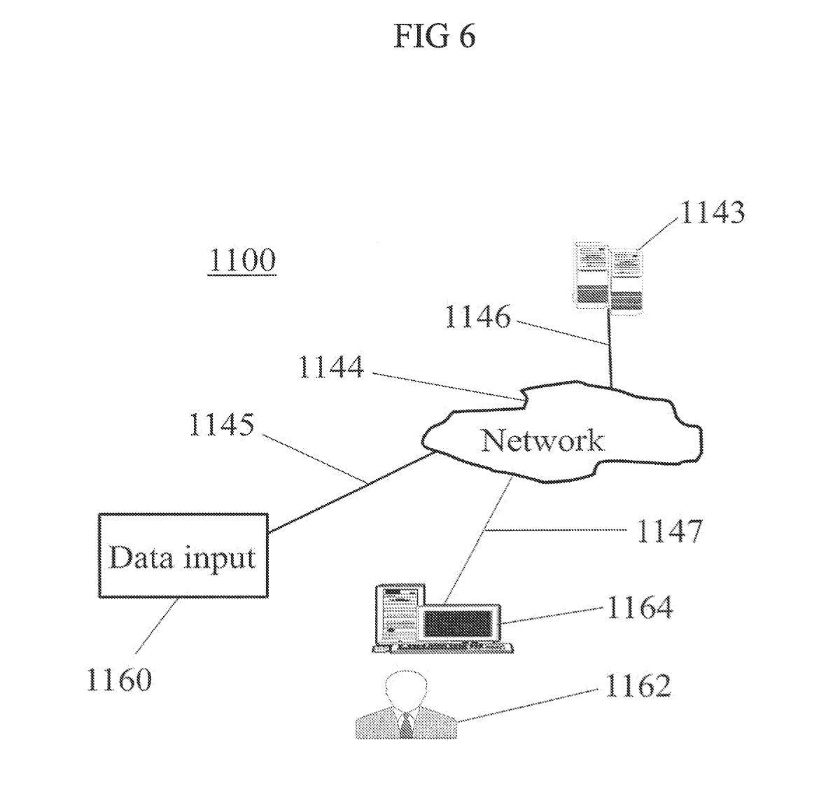

FIG. 6 is a representative diagram of various example system components usable for operation of one or more aspects of a system via a network, in accordance with an aspect of the present invention. FIG. 6 shows a communication system 1100 usable in accordance with the present invention. The communication system 1100 includes one or more data inputs 1160, such as may be provided by a sensor (e.g., a temperature or other sensor), and may optionally allow access and/or input by one or more accessors 1162 (also referred to interchangeably herein as one or more “users”) via one or more terminals 1164. In one aspect, data for use in accordance with the present invention is, for example, input by data input 1160 and/or accessed/input by accessors 1162 via terminal 1164, such as personal computers (PCs), minicomputers, mainframe computers, microcomputers, telephonic devices, or wireless devices, such as personal digital assistants (“PDAs”), smart phones, or other hand-held wireless devices coupled to a server 1143, such as a PC, minicomputer, mainframe computer, microcomputer, or other device having a processor and a repository for data and/or connection to a repository for data, via, for example, a network 1144, such as the Internet or an intranet, and couplings 1145, 1146, 1147. The couplings 1145, 1146, 1147 include, for example, wired, wireless, or fiberoptic links. In another variation, the method and system in accordance with aspects of the present invention operate in a stand-alone environment, such as on a single terminal.

In example variations of the present invention, the system may include different configurations. For example, the system may include a standalone machine, a countertop unit, or a through-wall machine. The machines may optionally be “self-service,” e.g., configured so that consumers may use aspects of the machine to service themselves.

Alternative aspects of the present invention may include one or more compressors. For example, the compressors may be 1.5 HP or 2 HP low temperature compressors. The compressors may have low temperature capability, such as the capability to reach temperatures as low as −49° F. Systems according to aspects of the present invention may also include one or more auxiliary compressors that are capable of maintaining a hopper mix at a temperature, for example, under 41° F.

Other aspects of the present invention may include one or more hoppers to contain material to be frozen (e.g., frozen yogurt mix). The hoppers may vary in size, for example, including 10.5-quart hoppers or 7.4-quart hoppers.

The one or more hoppers may include a sensor. The sensor may, for example, be a solid-state low level mix sensor that alerts a user when more mix is needed, such as via an audible alarm. The sensor may include an override switch to shut off the audible alarm. The one or more hoppers may include one or more agitators, such as magnetically driven agitators that keep powdered mixes spinning at a desired consistency.

Alternative aspects of the present invention may include one or more freezing cylinders. In one example implementation, the cylinders may comprise stainless steel. The cylinders may vary in size and may include, for example, a 2.3-quart cylinder.

In some variations of the present invention, the system may include two or four freezing cylinders. The system may be designed, for example, to vary product production capacity, such as from 40 quarts of product per hour, to 65 quarts of product per hour, to 130 quarts of product per hour.

Alternative aspects of the present invention can include microprocessor controls that may overlap components with or use the same as or different features from the control system that is used for controlling selection between cooling subsystems. The microprocessor controls may include a digital display. The controls may provide information about the system's usage, such as the number of servings of product used. The controls may also allow a user to adjust system and subsystem functions and operations, such as off-cycle mix frequency and blending speeds.

In some variations of the present invention, one machine may be configured to provide individual or separate systems and subsystems. For example, one machine may have two motors, two microcontrollers, two compressors, and/or two freezing cylinders, such that each system may operate and be controlled independently. The independent systems can allow one machine to produce two or more products contemporaneously, for example. For example, a user may adjust the blending speeds of the two or more systems so that two or more products with different viscosities and/or freezing requirements may be provided.

In some variations of the present invention, the product dispensing subsystem 14 may be configured with a user operable component to dispense the product. A system may include one or more user operable components to dispense individual flavors and/or combinations of flavors (also referred to interchangeably herein as a “twist”). For example, one machine may dispense two flavors and one twist, or four flavors and three twists. The user operable component may comprise a user operated handle, such as a spring return handle.

Alternative aspects of the present invention may include different modes or settings for different service phases. For example, the system can have a “nighttime” mode which allows the product to be kept overnight while using less energy, allowing energy and product savings.

While aspects of the present invention have been described and illustrated with reference to one or more preferred variations thereof, it is not the intention of the applicants that these aspects be restricted to such detail. Rather, it is the intention that aspects of the present invention be defined by all equivalents, both suggested hereby and known to those of ordinary skill in the art, of the variations falling within the scope thereof.

1. A freezing product related system, the system comprising:
a freezing product producing subsystem having a heat exchanger component;
a product dispensing subsystem interoperable with the freezing product producing subsystem;
at least two cooling subsystems interoperable with the heat exchanger component of the freezing product producing subsystem to provide cooling; and
a control subsystem;
wherein the control subsystem is configured to selectively control the implementation of the at least two cooling subsystems.

2. The system of claim 1, wherein the control subsystem is configured to:
receive input from one or more data sensors;
identify at least one of the at least two cooling subsystems based on the received input from the one or more data sensors; and
select the identified at least one cooling subsystem to provide cooling.

3. The system of claim 1, wherein the freezing product producing subsystem is an ice cream or frozen yogurt producing machine.

4. The system of claim 1, wherein the at least two cooling subsystems are selected from a group consisting of an air-cooled subsystem, a water-cooled subsystem, and a glycol-cooled subsystem.

5. The system of claim 1, wherein the control subsystem comprises a manual or automated control.

6. The system of claim 1, further comprising:
an implementation subsystem interoperable with the control subsystem.

7. The system of claim 2, wherein the control subsystem is configured to apply a determination methodology for selecting a cooling subsystem.

8. The system of claim 6, wherein the implementation system implements at least one of the cooling subsystems by actuating a valve to redirect the flow of a refrigerant.

9. The system of claim 8, wherein the implementation system implements at least two of the cooling subsystems contemporaneously.

10. The system of claim 7, wherein the determination methodology comprises at least one method selected from a group consisting of sensing external temperature, sensing water pressure or presence, sensing water temperature, and using preset or user defined parameters.

11. The system of claim 1, wherein the control system comprises hardware and software.

12. The system of claim 1, wherein the control subsystem comprises a computer system.

13. The system of claim 12, wherein the computer system comprises a processor, a display interface, and a communication interface.

14. The system of claim 13, wherein the display interface displays data via a display unit.

15. The system of claim 13, wherein the communication interface is configured to communicate data between the computer system and at least one device external to the computer system.

16. The system of claim 1, wherein the product dispensing subsystem is selected from a group consisting of a standalone machine, a through-wall machine, and a countertop machine.

17. The system of claim 16, wherein the product dispensing subsystem comprises at least two separate systems configured such that the product dispensing subsystem is capable of producing at least two separate freezing products.

18. A communication system for use in a freezing product related machine with at least two cooling subsystems, comprising:
at least one input;
a processor configured to receive data from the at least one input; and
a repository accessable by the processor;
wherein the processor is configured to:
receive data from the at least one input;
identify at at least one of the cooling subsystems for operation based on the at least one input; and
output an instruction for the at least one of the identified cooling subsystems to operate.

19. The system of claim 18, wherein the at least two inputs, include a sensor.

20. The system of claim 19, wherein the data received from the at least one input is selected from a group consisting of external temperature, water pressure or presence, water temperature, and one or more preset or user defined parameters.
